(19) United States
(12) Patent Application Publication
(10) Pub. No.: US 2013/0044843 A1
(43) Pub. Date: Feb. 21, 2013

(54) METHOD AND APPARATUS FOR PERFORMING TIMING SYNCHRONIZATION

(71) Applicants: Esa Mikael Malkamaki, Espoo (FI); Juha Sakari Korhonen, Espoo (FI)

(72) Inventors: Esa Mikael Malkamaki, Espoo (FI); Juha Sakari Korhonen, Espoo (FI)

(73) Assignee: NOKIA CORPORATION, Espoo (FI)

(21) Appl. No.: 13/213,682

(22) Filed: Aug. 19, 2011

(51) Int. Cl. H04L 7/00

(52) U.S. Cl. 375/356

(57) ABSTRACT

A method, apparatus and computer program product are provided in order to cause a timing alignment timer or a plurality of timing alignment timers to be reset based on a timing alignment timer message. In this regard, a method is provided that provides receiving a message. The method further includes determining whether the message includes a restart indication. The method additionally includes causing a plurality of timing alignment timers to be restarted in an instance in which the message includes a restart indication.

### TECHNOLOGICAL FIELD

Example embodiments of the present invention relate generally to communications technology and, more particularly, to signaling related to timing alignment timers (TAT).

### BACKGROUND

In Long Term Evolution (LTE), uplink transmissions on a physical uplink control channel (PUCCH) and physical uplink shared channel (PUSCH) are synchronized in such a way that signals, transmitted by different mobile terminals, arrive at receiver time aligned within cyclic prefix length at the serving cell. The time alignment of the uplink transmissions are generally controlled by Random Access Procedure and Maintenance of Uplink Time Alignment. Both of these are further described with reference to 3GPP 36.321 v. 10.2.0, which is hereby incorporated by reference in its entirety. By way of example, the initial synchronization between a mobile terminal is obtained during random access procedure: When a mobile terminal attempts to establish a connection with a serving cell, the mobile terminal transmits a Random Access Preamble (RAP), which enables a serving cell to estimate the transmission timing of the mobile terminal. In response, the serving cell then transmits a Random Access Response (RAR) to the mobile terminal which contains a timing advance (TA) message. The received TA message enables the mobile terminal to set the initial TA for transmitting on PUCCH and PUSCH. After the random access procedure, an access point such as a serving cell may continuously adjust uplink (UL) transmission timing of a mobile terminal by sending differential TA messages. The validity of TA is at least partially controlled by Time Alignment Timer (TAT) that is restarted every time mobile terminal receives a TA message. If the TAT expires, the mobile terminal is then unable to transmit on PUCCH or PUSCH before TA is obtained again using the above described random access procedure.

With the implementation of LTE and in particular LTE release 11, the mobile terminal may include a plurality of TATs to stay synchronized with one or more timing advance groups (TAG). A TAG may include one or more serving cells, access points, remote radio heads and/or the like. Generally, when the TAT of a TAG is running, the mobile terminal is allowed to transmit in an uplink resource of the serving cell(s) belonging to the TAG. In some instances a TAT of a TAG is reset (or restarted) by sending a TA message for that TAG. However when a TAT expires, the mobile terminal is no longer allowed to send in the uplink of the serving cell(s) belonging to the corresponding TAG (e.g., only transmissions of RAP are allowed in those cells once the TAT has expired).

Generally, TA messages are sent as a result of a changing distance between a mobile terminal and a serving cell (e.g., mobile terminal is moving). Therefore, in an instance in which the mobile terminal is not moving, a TA value may not change and thus TA messages will not generally be sent by the serving cell. However the TAT(s) will still need to be reset in a stationary mobile terminal or they will expire resulting in interrupted service to the mobile terminal. Therefore a TA message may have to be sent for each TAT running on the mobile terminal. As an example, with multiple TATs, this implies that several TA messages (one for each group) would have to be sent to reset the TATs which in turn requires the use of additional resources.

### BRIEF SUMMARY

A method, apparatus and computer program product are therefore provided according to an example embodiment in order to cause a TAT or a plurality of TATs to be reset based on a TA message. Based upon a TA message, a mobile terminal may be configured to restart all TATs, a portion of all TATs and/or a single TAT. In particular, the method, apparatus and computer program product of example embodiments of the present invention may restart a plurality of TATs when a TA message is received that contains a predetermined TA value.

In this regard, a method provides receiving a message. The method further includes determining whether the message includes a restart indication. The method additionally includes causing a plurality of timing alignment timers to be restarted in an instance in which the message includes a restart indication.

In another embodiment, an apparatus comprising a processor and a memory including software, the memory and the software configured to, with the processor, cause the apparatus to receive a message. The apparatus is further caused to determine whether the message includes a restart indication. The apparatus is further caused to cause a plurality of timing alignment timers to be restarted in an instance in which the message includes a restart indication.

In a further embodiment, a computer program product comprising at least one computer readable non-transitory memory having program code stored thereon, the program code which when executed by an apparatus cause the apparatus at least to receive a message. A computer program product is further configured to determine whether the message includes a restart indication. A computer program product is further configured to cause a plurality of timing alignment timers to be restarted in an instance in which the message includes a restart indication.

In this regard, an apparatus is provided that includes means for receiving a message. The apparatus further includes means for determining whether the message includes a restart indication. The apparatus additionally includes means for causing a plurality of timing alignment timers to be restarted in an instance in which the message includes a restart indication.

In this regard, a method is provided that includes generating a timing advance message containing a restart indication. The restart indication is configured to restart a plurality of timing alignment timers in a mobile terminal. The method further includes causing the timing advance message to be transmitted.

In another embodiment, an apparatus comprising a processor and a memory including software, the memory and the software configured to, with the processor, cause the apparatus to generate a timing advance message containing a restart indication. The restart indication is configured to restart a plurality of timing alignment timers in a mobile terminal. The apparatus is further caused to cause the timing advance message to be transmitted.

In another embodiment, a computer program product comprising at least one computer readable non-transitory memory having program code stored thereon, the program code which when executed by an apparatus cause the apparatus at least to generate a timing advance message containing a restart indication. The restart indication is configured to restart a plurality of timing alignment timers in a mobile terminal. The computer program product is further configured to cause the timing advance message to be transmitted.

In this regard, an apparatus is provided that includes means generating a timing advance message containing a restart indication. The restart indication is configured to restart a plurality of timing alignment timers in a mobile terminal. The apparatus further includes means for causing the timing advance message to be transmitted.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of an example system having a one or more timing advance groups that may be in communication with the mobile terminal and that may benefit from an embodiment of the present invention;

FIG. 2 is a block diagram of an example apparatus that may be embodied by a mobile terminal in accordance with one embodiment of the present invention;

FIG. 3 is a flow chart illustrating operations performed by an example mobile terminal in accordance with one embodiment of the present invention;

FIG. 4 is a flow chart illustrating operations performed by an example access point in accordance with one embodiment of the present invention; and

FIG. 5 illustrates an example TA message as used in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

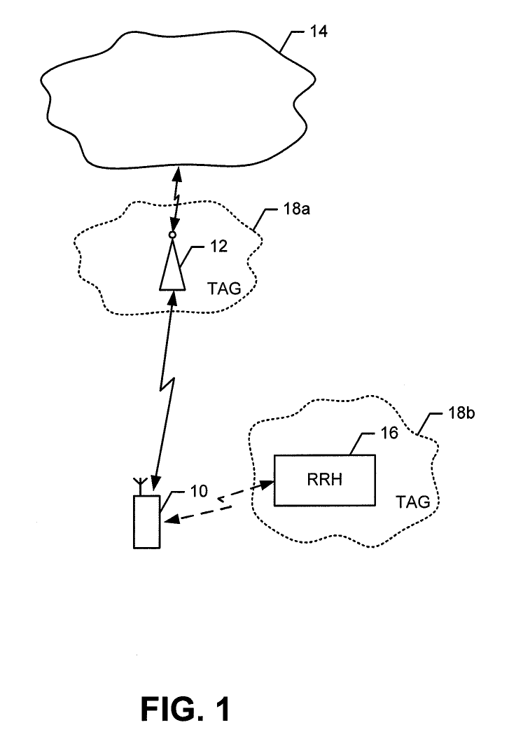

Although the method, apparatus and computer program product may be implemented in a variety of different systems, one example of such a system is shown in FIG. 1, which includes a first communication device (e.g., mobile terminal 10) that is capable of communication via a base station 12, such as a Node B, an evolved Node B (eNB) or other access point, with a network 14 (e.g., a core network). While the network may be configured in accordance with LTE or LTE-Advanced (LTE-A), other networks may be used in some embodiments, including those configured in accordance with wideband code division multiple access (W-CDMA), CDMA2000, global system for mobile communications (GSM), general packet radio service (GPRS) and/or the like.

When referred to herein, a serving cell, such as base station 12, includes, but is not limited to a primary serving cell (PCell) and other serving cells such as secondary serving cells (SCell). A PCell generally includes, but is not limited to, a cell that is configured to perform initial establishment procedures, security procedures, system information (SI) acquisition and change monitoring procedures on the broadcast channel (BCCH), and paging. The SCell, which may be embodied by a remote radio head (RRH), such as RRH 16, is configured to provide additional radio resources to the PCell.

The network 14 may include a collection of various different nodes, devices or functions that may be in communication with each other via corresponding wired and/or wireless interfaces. For example, the network may include one or more cells, including base station 12 and an RRH 16, each of which may serve and/or relate to a respective coverage area. The serving cell and the RRH may be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

A communication device, such as the mobile terminal 10 (also known as user equipment, a wireless transmit receive unit and/or the like), may be in communication with other communication devices or other devices via the base station 12, the RRH 16 and, in turn, the network 14. In some cases, the communication device may include an antenna for transmitting signals to and for receiving signals from a serving cell.

In one embodiment, the mobile terminal 10 may be connected to at least one base station, such as base station 12, with configured UL resources. The base station, such as base station 12, may include a plurality of corresponding component carriers that may be grouped into a TAG, such as TAG 18. The TAG grouping may be based on the UL carrier, TA and/or the like. For example, each carrier with the same TA may advantageously be grouped. In such an example, the mobile terminal 10 may establish time synchronization with each TAG 18, which in turn results in synchronization with all of the cells and/or carriers related to that TAG 18. By grouping carriers with the same TA, there is an advantageous reduction in the total signaling needed to maintain timing synchronization.

Alternatively or additionally, in an instance in which a mobile terminal, such as mobile terminal 10, is configured with carrier aggregation such that it is receiving from and transmitting to two geographically separated nodes, such as base station 12 (e.g., providing PCell) and RRH 16 (e.g., providing SCell)., Further, based on the different geographic location of the separated nodes, the signal propagation delays between the mobile terminal and the two nodes will likely be different. Therefore the mobile terminal may receive different TA values for the two nodes allowing the nodes to be grouped according to their respective TA values. Such groupings are shown with reference to FIG. 1, wherein an RRH 16 having one or more carriers may belong to TAG 18b, while the base station 12 having one or more carriers belong to TAG 18a.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal 10 may include one or more processors that may define processing circuitry either alone or in combination with one or more memories. The processing circuitry may utilize instructions stored in the memory to cause the mobile terminal 10 to operate in a particular way or execute specific functionality when the instructions are executed by the one or more processors. The mobile terminal 10 may also include communication circuitry and corresponding hardware/software to enable communication with other devices and/or the network 14.

A method, apparatus and computer program product are therefore provided according to an example embodiment in order to cause a TAT or a plurality of TATs to be reset (e.g. restarted) based on a message, for example and as described herein, the message may be a TA medium access control (MAC) control element (CE) message (hereinafter “TA message”). By way of example and not of limitation the term TA message may be used interchangeably with the term TA command. For example, based on a TA value received within a message, such as a TA message, a mobile terminal, such as mobile terminal 10, may be configured to restart all currently running TAT(s).

In an instance in which a TAT expires, a mobile terminal, such as mobile terminal 10, would be prevented from transmitting in a UL. To prevent the TAT from expiring, in an embodiment, a serving cell may transmit a message, such as a TA message to restart a TAT and/or a plurality of TATs. In particular, the method, apparatus and computer program product of example embodiments of the present invention may restart a plurality of TATs when a message, such as a TA message is received that contains a predetermined TA value. In an instance in which a message is received without a predetermined TA value, the mobile terminal, such as mobile terminal 10 may instead adjust the TA and restart a TAT for a particular TAG and/or serving cell, such as base station 12.

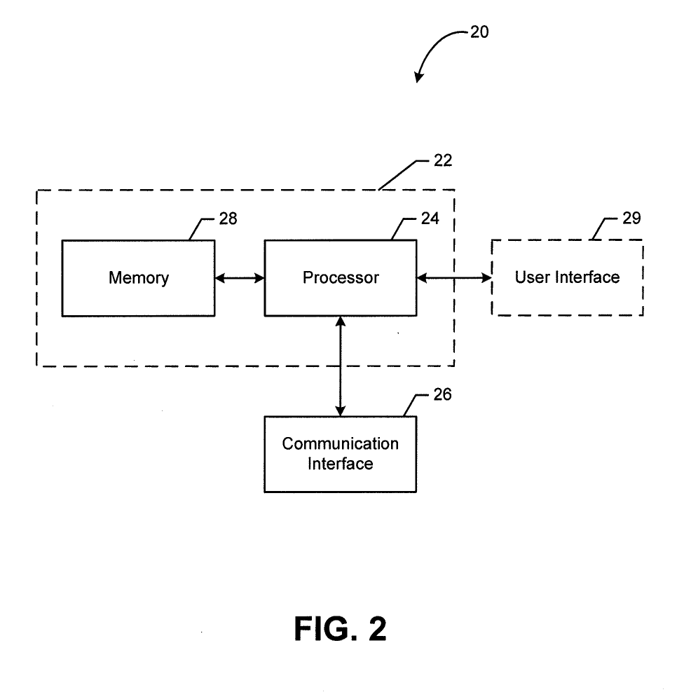

In an embodiment, for example, the mobile terminal 10 and/or the base station 12 may be embodied as or otherwise include an apparatus 20 as generically represented by the block diagram of FIG. 2. While the apparatus 20 may be employed, for example, by a mobile terminal 10 or a base station 12, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with some example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 29. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 29 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 20 need not always include a user interface. For example, in instances in which the apparatus is embodied as a base station 12, the apparatus may not include a user interface. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry 22, such as between the mobile terminal 10 and the base station 12. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

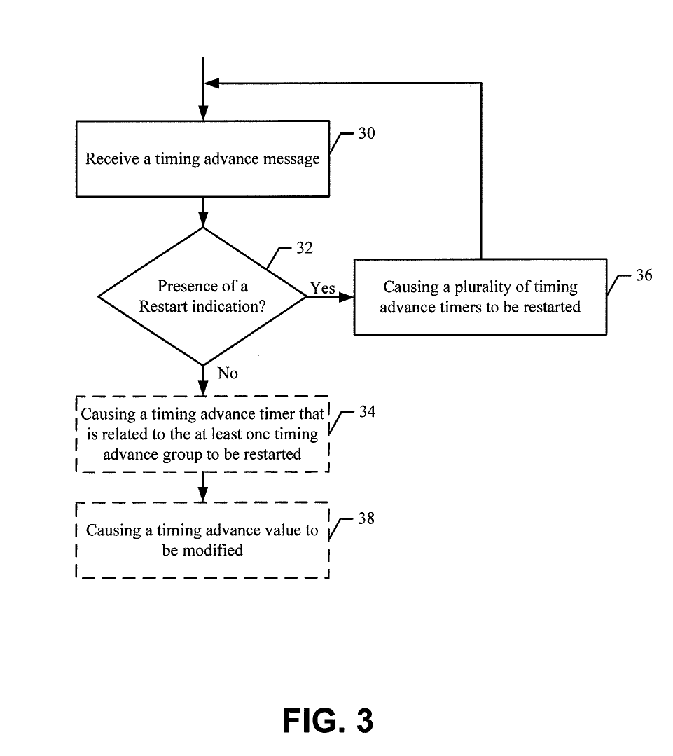

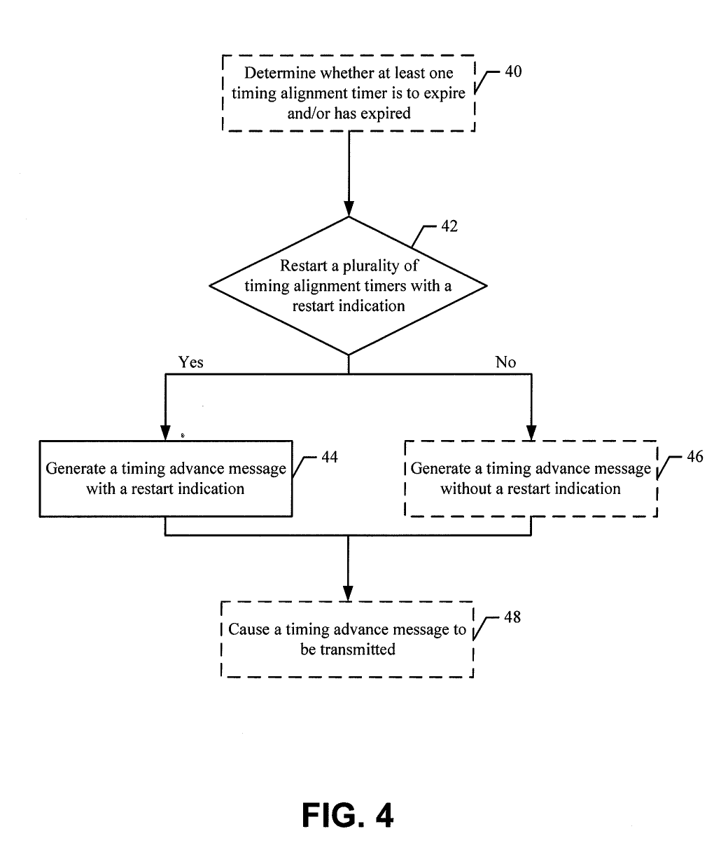

FIGS. 3 and 4 illustrate example flowcharts of the operations performed by a method, apparatus and computer program product, such as apparatus 20 of FIG. 2, in accordance with one embodiment of the present invention are illustrated. It will be understood that each block of the flowcharts, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing circuitry 22, e.g., processor, to perform an example embodiment. In some cases, a general purpose computer may be provided with an instance of the processor which performs the algorithm of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations herein may be modified or further amplified as described below. Moreover, in some embodiments additional optional operations may also be included (some examples of which are shown in dashed lines in FIG. 3). It should be appreciated that each of the modifications, optional additions or amplifications below may be included with the operations above either alone or in combination with any others among the features described herein.

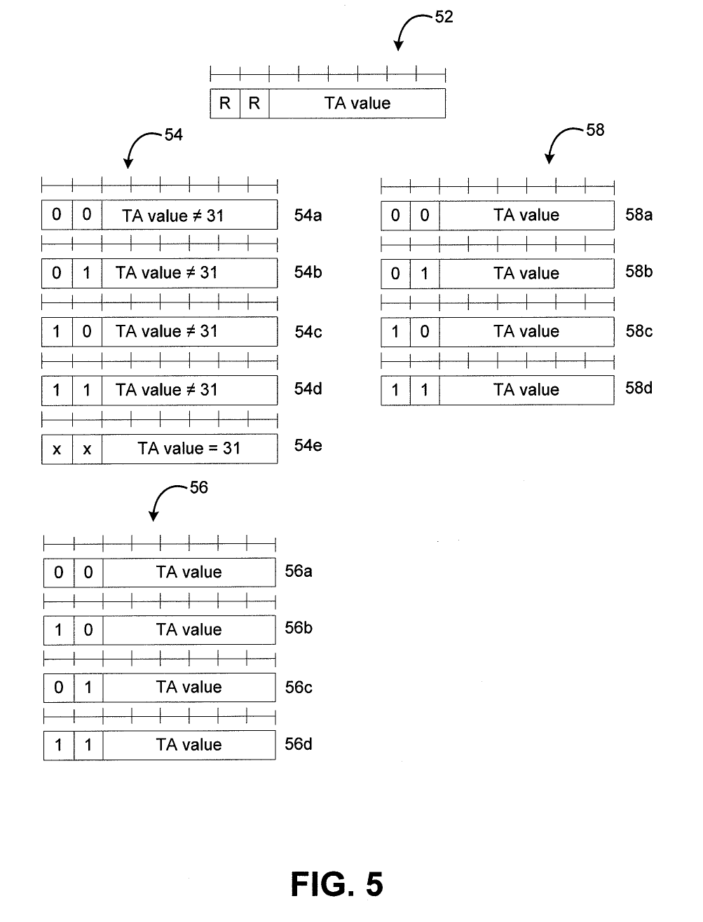

FIG. 3 is an example flowchart illustrating receiving a message, such as a TA message and in response restarting at least one TAT performed in accordance with an embodiment of the present invention. As shown in operation 30, the apparatus 20 embodied, for example, by a mobile terminal 10, may include means, such as the processing circuitry 22, the processor 24, the communications interface 26 or the like, for receiving a message, such as a TA message. In an embodiment, a message, such as a TA message may be received by a mobile terminal, such as the mobile terminal 10. A TA message may contain eight bits, which include two reserved bits (R) and six bits that are used to represent a TA value. See for example element 52 of FIG. 5. For example the TA value bits of the TA message may instruct a mobile terminal, such as mobile terminal 10, how much a current TA should be changed. For example, 3GPP TS 36.213 V 10.2.0 (2011-06), which is incorporated by reference as if set forth in its entirety herein, describes how a current TA is modified. The six bit TA value, T_{A}, indicates adjustment of the current N_{TA} value, N_{TA,old}, to the new N_{TA} value, N_{TA,new}, by index values of T_{A}=0, 1, 2, . . . , 63, where N_{TA,new}=N_{TA,old}+(T_{A}−31)×16. Here, adjustment of N_{TA} value by a positive or a negative amount indicates advancing or delaying the UL transmission timing by a given amount respectively.

Alternatively or additionally, in an instance in which there are multiple TAGs, the one or two reserved bits may be used to indicate a particular TAG. For example, when a reserved bit is used as a TAG identifier, the corresponding TA value is used to adjust the TA relating to the indicated TAG.

As shown in decision operation 32 of FIG. 3, the apparatus 20 may also include means, such as the processing circuitry 22, the processor 24 or the like, for determining the presence of a restart indication. For example a restart indication may use one and/or a combination of the reserved bits of a TA message to indicate that a plurality of TATs are to be restarted. As shown with reference to FIG. 5, element 56 shows an example of an instance in which one of the reserved bits is used as a restart indication and the other as a TAG identifier. For example the first reserved bits of 56a and 56b may be used to indicate a particular TAG, whereas the second reserved bit when set to a 1, as shown in 56c and 56d, may indicate that a plurality of TATs are to be restarted. In alternate embodiments, the first bit may be used to indicate that a plurality of TATs are to be restarted and the second reserved bit may be used as a TAG identifier. In an example, in case of receiving elements 56c or 56d, the TA message may be applied for one of TAGs, restarting the TAT of that TAG, while the TA of the other TAG is not changed but only the TAT of that TAG is restarted.

Alternatively or additionally, as shown with reference to FIG. 5, element 58 illustrates an example instance in which a particular combination of the reserved bits may indicate that a plurality of TATs are to be restarted. For example the combination of reserved bits in 58a, 58b, and 58c may identify a particular TAG, whereas the (1, 1) reserved bit combination in 58d may be used to indicate that a plurality of TATs are to be restarted. In alternate embodiments a combination other than (1, 1) may be used.

In yet another embodiment, the TA value of the TA message may be used to represent a restart indication. For example, the predetermined TA value that may cause the plurality of TATs to restart may be a specific value such as 0 or 63. These values may be chosen because they represent the maximum TA change and thus are seldom used. A value of 31 may be also chosen, because a TA value of 31 results in no change to the TA. For example, and as is shown with reference to element 54 of FIG. 5, the reserve bits may be used to indicate a particular TAG as is shown in 54a-54d, whereas a TA value of 31 would indicate that a plurality of TATs are to be restarted as is shown in 54e. Other values may optionally be used. In some embodiments, however, the TA value that is chosen would not be used to indicate a change in a TA and thus when the TA value was received by the mobile terminal, the TA would remain unchanged while the plurality of TATs would be restarted.

In an instance in which the restart indication is present, as shown in operation 36 of FIG. 3, the apparatus 20 may also include means, such as the processing circuitry 22, the processor 24 or the like, for causing the plurality of TATs to be restarted. In an embodiment each of the TATs that are currently executing on a mobile device, such as mobile terminal 10, may be restarted. However in alternate embodiments, a portion and/or a single TAT of the running TATs may be restarted.

Alternatively or additionally, a mobile terminal, such as the mobile terminal 10, may be configured to restart the plurality of TAT's in an instance in which the restart indication is received from the PCell, such as base station 12. Optionally, if a restart indication is received from any other cell such as the SCell belonging to a TAG not containing the PCell, then the restart indication would only adjust the TA and restart the TAT corresponding to that SCell or TAG.

In an instance in which the restart indication is not present, as shown in operation 34 of FIG. 3, the apparatus 20 may also include means, such as the processing circuitry 22, the processor 24 or the like, for causing a TAT that is related to at least one TAG and/or a serving cell, such as base station 12, to be restarted. In an example embodiment, the TAT related to the TAG and/or serving cell that transmitted the message, such as the TA message may be restarted.

As shown in operation 34 of FIG. 3, the apparatus 20 may also include means, such as the processing circuitry 22, the processor 24 or the like, for causing a TA value to be modified. As described herein, a TA value may be modified such that a mobile terminal remains synchronized.

FIG. 4 is an example flowchart illustrating the generation of a message, such as a TA message, that is configured to restart at least one TAT performed in accordance with an embodiment of the present invention. As shown in operation 40, the apparatus 20 embodied, for example, by a base station 12, may include means, such as the processing circuitry 22, the processor 24 or the like, for determining whether at least one TAT is to expire and/or has expired. For example, to determine whether a TAT is to expire, an apparatus, such as base station 12, may determine a time since the last TA message was transmitted to the mobile terminal. Using the determined time since the last transmission, the base station 12 may then determine that the mobile terminal TAT is to expire based on a comparison between the determined time and a length of a TAT.

Alternatively or additionally, the base station 12 may determine that the mobile device has remained stationary for a predetermined amount of time and, as described herein, a stationary mobile terminal will generally not receive TA messages. Therefore the apparatus, such as the base station 12, may then determine when the mobile terminal TAT is to expire based on a comparison between the determined stationary period of the mobile station and a length of a TAT.

Alternatively or additionally, the apparatus, such as the base station 12, may receive, using means such as the communications interface 28, an indication from a mobile terminal that notifies the base station 12 that a mobile terminal TAT is to expire.

As shown in decision operation 42, the apparatus 20 embodied, for example, by a base station 12, may include means, such as the processing circuitry 22, the processor 24 or the like, for deciding if a plurality of TATs are to be restarted with a restart indication. For instance, if UL timings to all the TAGs have been recently checked and there is no need to adjust any of the timings, all the TAGs may be restarted with a restart indication. In an instance in which the plurality of TATs are to be restarted with a restart indication then, as shown in operation 44, the apparatus 20 embodied, for example, by a base station 12, may include means, such as the processing circuitry 22, the processor 24 or the like, for generating a message, such as a TA message with a restart indication. In an example embodiment, the message, such as the TA message, with the restart indication is sent in an instance in which there is not a need to adjust the TA.

Whereas, in an instance in which the plurality of TATs are not to be restarted, then as shown in operation 46, the apparatus 20 embodied, for example, by a base station 12, may include means, such as the processing circuitry 22, the processor 24 or the like, for generating a TA message without a restart indication. For instance, it may not be appropriate to restart a plurality of TATs with a restart indication if one of the TATs has expired and the TA of the corresponding TAG could be invalid. As shown in operation 48, the apparatus 20 embodied, for example, by a base station 12, may include means, such as the processing circuitry 22, the processor 24, the communications interface 26 or the like, for causing the generated TA message to be transmitted.

Advantageously, the apparatus 20, method and computer program product as described herein enables a mobile terminal 10 to restart a plurality of TATs based on a single message, such as a TA message. In some cases, a message, such a TA message, is necessary when a mobile terminal has remained stationary. In some embodiments a serving cell may determine that the mobile terminal has remained stationary and may transmit a message, such as a TA message with a restart indication to the mobile terminal. Additionally or alternatively, the apparatus, method and computer program product as described herein further may allow for a reduction in signaling by allowing a single message, such as a TA message, to restart the plurality of TATs. The reduction in signaling may also result in a reduced overhead and power consumption by the mobile terminal.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a message;
determining, using a processor, whether the message includes a restart indication; and
in an instance in which the message includes a restart indication, causing a plurality of timing alignment timers to be restarted.

2. A method of claim 1, further comprises in an instance in which the message does not include a restart indication, causing a timing alignment timer that is related to at least one timing advance group to be restarted.

3. A method of claim 1, wherein the message comprises a timing advance message.

4. A method of claim 3, wherein the restart indication comprises a predetermined timing advance value within the received timing advance message.

5. A method of claim 1 further comprises in an instance in which the message does not include a restart indication, causing a timing advance value to be modified.

6. A method of claim 1 further comprises in an instance in which the restart indication is received for a timing advance group that comprises a primary cell, causing a plurality of timing alignment timers to be restarted.

7. A method of claim 1, further comprises in an instance in which the restart indication is received for a timing advance group that comprises a secondary cell, causing a timing alignment timer that is related to the timing advance group to be restarted.

8. An apparatus comprising:
a processor and
a memory including software, the memory and the software configured to, with the processor, cause the apparatus to at least:
receive a message;
determine whether the message includes a restart indication; and
in an instance in which the message includes a restart indication, cause a plurality of timing alignment timers to be restarted.

9. An apparatus according to claim 9, wherein the at least one memory including the computer program code is further configured to, with the at least one processor, cause the apparatus to, in an instance in which the message does not include a restart indication, cause a timing alignment timer that is related to at least one timing advance group to be restarted.

10. An apparatus according to claim 10, wherein the message comprises a timing advance message.

11. An apparatus according to claim 11, wherein the restart indication comprises a predetermined timing advance value within the received timing advance message.

12. An apparatus according to claim 8, wherein the at least one memory including the computer program code is further configured to, with the at least one processor, cause the apparatus to, in an instance in which the message does not include a restart indication, cause a timing advance value to be modified.

13. An apparatus according to claim 8, wherein the at least one memory including the computer program code is further configured to, with the at least one processor, cause the apparatus to, in an instance in which the restart indication is received for a timing advance group that comprises a primary cell, cause a plurality of timing alignment timers to be restarted.

14. An apparatus according to claim 8, wherein the at least one memory including the computer program code is further configured to, with the at least one processor, cause the apparatus to, in an instance in which the restart indication is received for a timing advance group that comprises a secondary cell, causing a timing alignment timer that is related to the timing advance group to be restarted.

15. An apparatus comprising:
a processor and
a memory including software, the memory and the software configured to, with the processor, cause the apparatus to at least:
generate a timing advance message containing a restart indication, wherein the restart indication is configured to restart a plurality of timing alignment timers in a mobile terminal; and
cause the timing advance message to be transmitted.

16. An apparatus according to claim 15, wherein the at least one memory including the computer program code is further configured to, with the at least one processor, cause the apparatus to determine whether at least one timing alignment timer advance group is to expire.

17. An apparatus according to claim 16, wherein the at least one memory including the computer program code is further configured to, with the at least one processor, cause the apparatus to in an instance in which the at least one time alignment timer is to expire, generate a timing advance message with a restart indication.

18. An apparatus according to claim 15, wherein the at least one memory including the computer program code is further configured to, with the at least one processor, cause the apparatus to, in an instance in which a time advance with a mobile terminal is not synchronized, cause a time advance message without a restart indication to be transmitted.

19. An apparatus according to claim 15, wherein the at least one memory including the computer program code is further configured to, with the at least one processor, cause the apparatus to determine whether at least one of a timing alignment timer is to expire by an expiration of a period, wherein during the period a TA message was not transmitted; determining whether a mobile terminal has not moved for a period equal to a duration of the at least one timing alignment timer or receiving an indication from a mobile terminal.

20. An apparatus according to claim 15, wherein the restart indication comprises a predetermined timing advance value within the timing advance message.
